(19) United States
(12) Patent Application Publication
(10) Pub. No.: US 2009/0067304 A1
(43) Pub. Date: Mar. 12, 2009

(54) OPTICAL RECORDING APPARATUS AND CONTROL METHODS THEREOF

(75) Inventors: Hung-Hsiang Chang, Hsinchu County (TW); Ying-Feng Huang, Chia-Yi Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/850,706

(22) Filed: Sep. 6, 2007

(51) Int. Cl. G11B 5/00

(52) U.S. Cl. 369/47.53

(57) ABSTRACT

An optical recording apparatus. A laser diode driver performs optimum power calibration according to a predetermined target value to obtain reference recording power, and adjusts the reference recording power to obtain testing recording power settings. A signal process device obtains recording qualities respectively in predetermined test regions of an optical storage medium corresponding to the reference recording power and the testing recording power settings. A processor obtains an optimum recording power according to the recording quality, obtains an optimum target value corresponding to the optimum recording power. The optimum target value is then used for data recording.

### BACKGROUND OF THE INVENTION

1. Field of the Invention

The invention relates to optical recording apparatuses, and more particularly to optical recording apparatuses and methods for calibrating recording power thereof.

2. Description of the Related Art

In a conventional optical recording system, such as a rewritable optical disc drive for an optical storage medium, such as a compact disc-recordable (CD-R), a digital video disc-recordable (DVD-R, DVD+R, DVD+RDL, DVD-RDL), a digital video disc-rewritable (DVD-RW, DVD+RW, DVDRWDL), Blu-Ray BD/HD or the like, optimization of recording power is carried out, before actually recording desired data, and this procedure is normally referred to as optimum power calibration (OPC). The term “recording power” described hereinafter refers to the light emitting intensity of a laser diode as a light-emitting element forming pits for recording, and used in recording/reproducing the data in an optical disc. During optimum power calibration, recording power is varied in a plurality of steps in several sectors, e.g., 16 steps in 16 sectors, and test data is recorded in a test region provided in a predetermined location of the optical disc. Thereafter, test data is reproduced in a sector to evaluate its quality.

Optimum power calibration is performed according to a target value, such as beta target value (for DVD-R, DVD+R, DVD+RDL, DVD-RDL) or gamma target values (for DVD-RW, DVD+RW, DVDRWDL). The target value is obtained from a table pre-stored in a buffer of an optical disc recording apparatus. Discs manufactured by the same maker and with the same recording parameters, such as recording speed or disc type, are distributed with the same beta target value.

However, due to manufacturing and material variations of optical discs, or different types of laser diodes, accuracy of optimum power obtained from the OPC according to the fixed target value may be decreased, deteriorating recording quality.

### BRIEF SUMMARY OF INVENTION

Optical recording apparatuses and methods of recording power control are provided. An exemplary embodiment of a method of recording power control when recording data to an optical storage medium comprising performing an optimum power calibration according to a predetermined target value to obtain a reference recording power, adjusting the reference recording power to obtain a plurality of testing recording power settings, respectively recording test data to a plurality of predetermined test regions of the optical storage medium according to the reference recording power and the testing recording power settings, obtaining recording quality respectively in the predetermined test regions corresponding to the reference recording power and the testing recording power settings, obtaining an optimum recording power according to the recording quality, and obtaining an optimum target value corresponding to the optimum recording power, updating the predetermined target value with the optimum target value.

Another exemplary embodiment of a method of recording power control to record data to an optical storage medium comprising recording test data to a first predetermined test region of the optical storage medium according to a predetermined recording power, adjusting the predetermined recording power to obtain a plurality of testing recording power settings, recording the test data to a plurality of second predetermined test regions of the optical storage medium respectively according to the testing recording power settings, obtaining recording quality in the first predetermined test region corresponding to the predetermined recording power and in the second predetermined test regions respectively corresponding to the testing recording power settings, obtaining a reference recording power according to the recording quality, performing an optimum power calibration according to the reference recording power to obtain an optimum recording power, obtaining an optimum target value corresponding to the optimum recording power, and recording data to the optical storage medium according to the optimum target value.

An exemplary embodiment of an optical recording apparatus to record data to an optical storage medium having a plurality of predetermined test regions comprising a laser diode driver performing an optimum power calibration according to at least one of predetermined target values to obtain at least one of reference recording power, and adjusting the reference recording power to obtain at least one of testing recording power settings, a signal process device obtaining at least one of recording qualities respectively in the predetermined test regions corresponding to the reference recording power and the testing recording power settings, and a processor obtaining an optimum recording power according to the recording quality, and obtaining an optimum target value corresponding to the optimum recording power.

Another exemplary embodiment of an optical recording apparatus to record data to an optical storage medium comprising an optical pickup recording test data to a first predetermined test region of the optical storage medium according to a predetermined recording power, and recording the test data to a plurality of second predetermined test regions of the optical storage medium respectively according to a plurality of testing recording power settings, a laser diode driver providing the predetermined recording power, adjusting the predetermined recording power to obtain the testing recording power settings, and performing an optimum power calibration according to a reference recording power to obtain an optimum recording power, a signal process device obtaining recording quality in the first predetermined test region corresponding to the reference recording power and in the second predetermined test regions respectively corresponding to the testing recording power settings, and a processor obtaining the reference recording power according to the recording quality, and obtaining an optimum target value corresponding to the optimum recording power.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of an optical recording apparatus according to an embodiment of the invention;

FIG. 2 is a flowchart of a method for controlling recording power to record data to an optical storage medium according to an embodiment of the invention;

FIG. 3 is a flowchart of a method for controlling recording power to record data to an optical storage medium according to another embodiment of the invention.; and

FIG. 4 is a flowchart of a method for controlling recording power to record data to an optical storage medium according to another embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

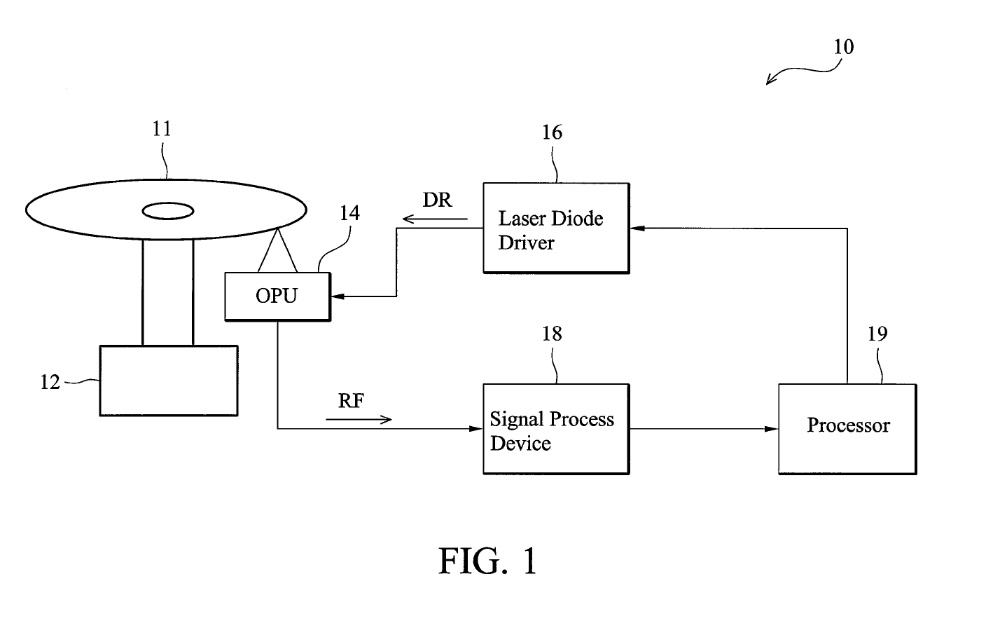

FIG. 1 is a block diagram of an optical recording apparatus according to an embodiment of the invention. The optical disk recording apparatus 10 comprises a disk rotation drive unit 12 including a spindle motor, an optical pick up unit (OPU) 14, a laser diode driver 16, a signal process device 18, and a processor 19.

The optical pick up unit 14 includes a light-emitting element, i.e., a laser diode (LD) for illuminating an optical disk 11 with a laser light spot to record and/or reproduce data, a light-receiving element and focus optics for focusing the light emitted from the light-emitting element to the optical disk 11. A driving signal DR for recording is supplied from laser diode driver 16, and the data is recorded in the form of pits having a length of 3T to 14T (where T is a reference unit for a recording mark length in the track direction).

In addition, laser diode driver 16 generates a driving signal driving the laser diode in the optical pick up unit 14. In an embodiment, the power of the driving signal can be determined according to a predetermined power. In an alternative embodiment, the power of the driving signal can be determined according to a predetermined target value pre-stored in an external memory device or the optical disk 11. Moreover, laser diode driver 16 performs optimum power calibration (OPC) accordingly to adjust the recording power. During OPC, the recording power is stepwise altered within 16 steps in each of 16 sectors, and test data is recorded then reproduced in each sector to determine an evaluation index. After determining the evaluation index for each recording power setting, the laser diode driver 16 sequentially stores the evaluation indices as a function of the recording power (the function of evaluation index against recording power) and then adjusts the recording power.

In addition, a laser light having a recording power is focused on the optical disk 11 to receive the light reflected therefrom, and then a reproducing signal RF corresponding to the reflected light is supplied to the signal process device 18. “Recording power” noted herein represents the light intensity emitted from laser diode driver 16 during reproduction. The signal process unit 18 obtains recording quality corresponding to the recording power. In some embodiments of the invention, recording quality can be obtain from the inner code (PI) error rate or jitter value of reproducing signal RF. After obtaining the recording quality corresponding to different power settings, processor 19 obtains an optimum recording power according to the recording quality, an optimum target value corresponding to the optimum recording power, and updates the predetermined target value with the optimum target value.

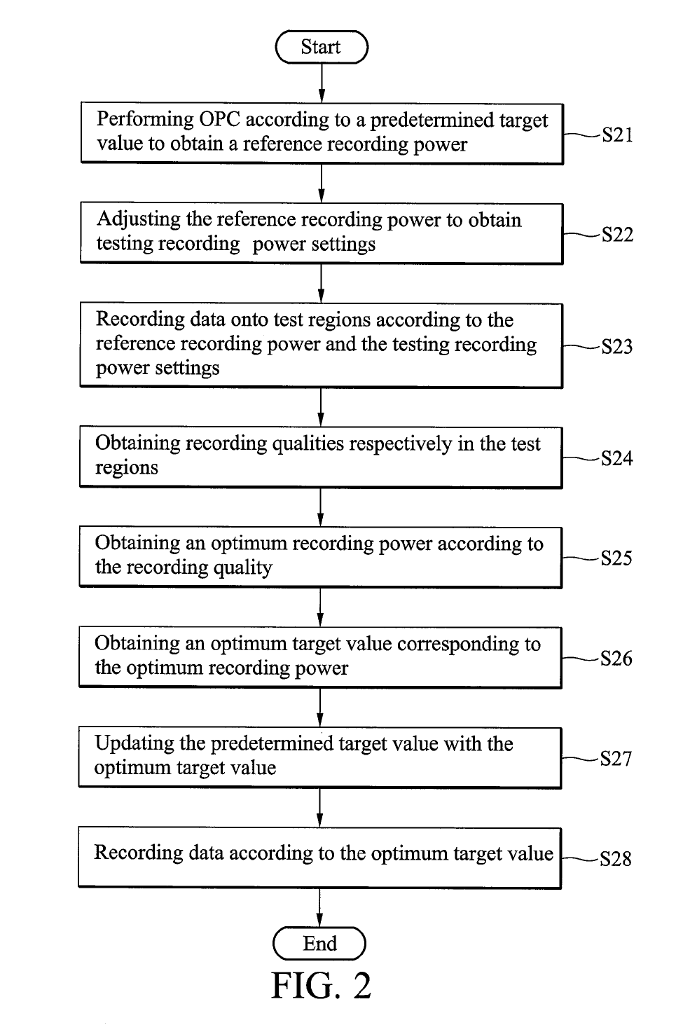

FIG. 2 is a flowchart of a method for controlling recording power to record data to an optical storage medium according to an embodiment of the invention. As the optical disk 1 is inserted, the laser diode driver 16 reads a predetermined target value, and performs optimum power calibration according to the predetermined target value to obtain a reference recording power (S21). Next, laser diode driver 16 adjusts the reference recording power to obtain a plurality of testing recording power settings (S22). In an embodiment of the invention, the testing recording power settings are generated according to the reference recording power and a predetermined difference, for example, adding the predetermined difference to the reference recording power to get a first testing recording power, and subtracting the predetermined difference from the reference recording power to get a second testing recording power. In another embodiment, a first, second, third, and fourth testing recording power can be generated by summing the reference recording power and twice the predetermined difference, summing the reference recording power and the predetermined difference, subtracting the predetermined difference from the reference recording power, and subtracting twice the predetermined difference from the reference recording power, respectively. In an embodiment of the invention, the predetermined difference is 10% of the reference recording power.

Next, the optical pick up unit 14 records test data to a plurality of predetermined test regions of the optical storage medium 15 according to the reference recording power and the testing recording power settings, respectively (S23). For example, three predetermined test regions are recorded with test data respectively using a first testing recording power, the reference recording power, and a second testing recording power.

Next, the signal process unit 18 obtains recording quality respectively in the predetermined test regions corresponding to the reference recording power and the testing recording power settings (S24). As described, recording quality of each test region can be obtained from the PI error rate or jitter value of the reproducing signal RF corresponding to each test region. Next, the processor 19 obtains an optimum recording power according to the recording quality of each predetermined test region (S25). The optimum recording power is determined when the recording power achieves a relative high recording quality among the other recording power settings, or exceeds a reference value. As the optimum recording power is obtained, the processor 19 obtains an optimum target value corresponding to the optimum recording power (S26). In an embodiment of the invention, the optimum target value can be obtained according to the optimum recording power from a look up table. Next, the processor 19 updates the predetermined target value with the optimum target value (S27).

In an embodiment of the invention, the optimum recording power can be one of the generated first and second testing recording power settings, or the original reference recording power, depending on whether the best recording quality can be obtained. In another embodiment of the invention, the optimum recording power can be an interpolated value derived from at least two of the testing recording power settings and the original reference recording power. In addition, test regions can be located in an inner zone or outer zone of the optical storage medium 15, or located in the inner and outer zones of the optical storage medium 15. In another embodiment of the invention, since recording quality corresponding to the inner and outer zones of the optical storage medium 15 with single recording power may be different, optimum recording power may be adjusted depending on the recording location in the optical storage medium 15 according to the recording quality corresponding to the inner zone and the outer zone of the optical storage medium. After the optimum target value is updated, the real data to be recorded is recorded to the optical storage medium 15 according to the updated optimum target value (S28).

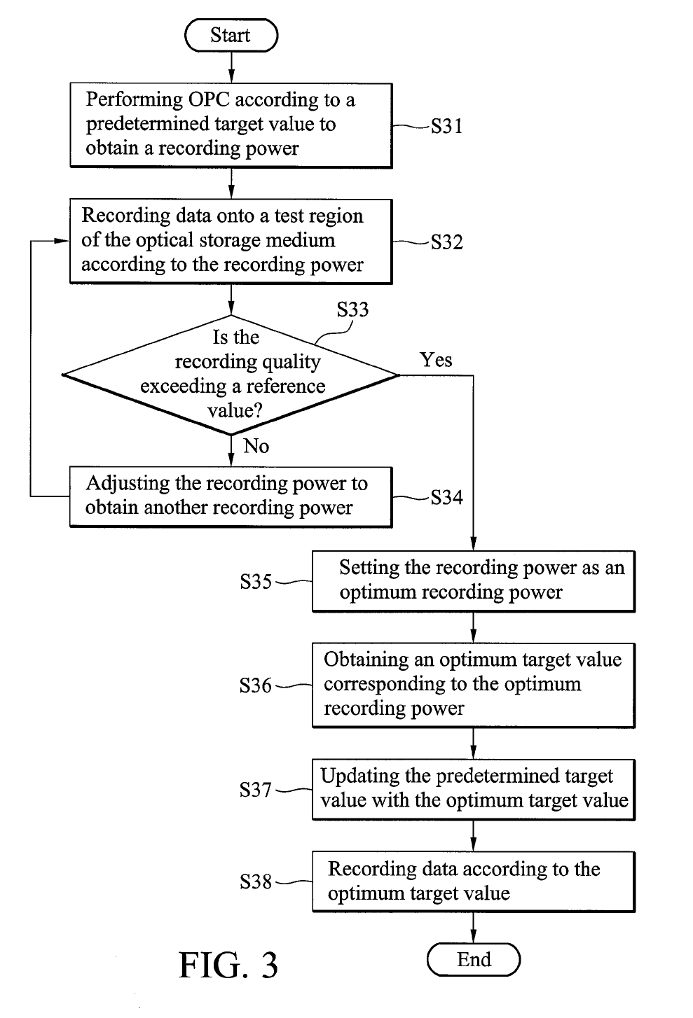

FIG. 3 is a flowchart of a method for controlling recording power to record data to an optical storage medium according to another embodiment of the invention. As an optical disk 11 is installed, the laser diode driver 16 reads a predetermined target value, and performs the optimum power calibration according to the predetermined target value to obtain a recording power (S31). Next, the optical pick up unit 14 records test data to the predetermined test region of the optical storage medium 15 according to the recording power (S32). Next, the signal process unit 18 obtains the recording quality in the predetermined test region, and the processor 19 determines whether the recording quality exceeds a reference value (S33). If not, the laser diode driver 16 adjusts the recording power to generate another recording power (S34). Next, the process returns to step S32 to record test data to the predetermined test region of the optical storage medium 15 according to the recording power (S32). In an embodiment of the invention, the recording power settings are generated according to the original recording power and a predetermined difference. For example, the generated recording power can be a sum of the original recording power and the predetermined difference or a difference between the original recording power and the predetermined difference. If the recording quality exceeds a reference value, the present recording power is set as an optimum recording power (S35). As the optimum recording power is obtained, the signal process unit 18 obtains an optimum target value corresponding to the optimum recording power (S36), and updates the predetermined target value with the optimum target value (S37). After the optimum target value is updated, the real data to be recorded is recorded to the optical storage medium 15 according to the updated optimum target value (S38).

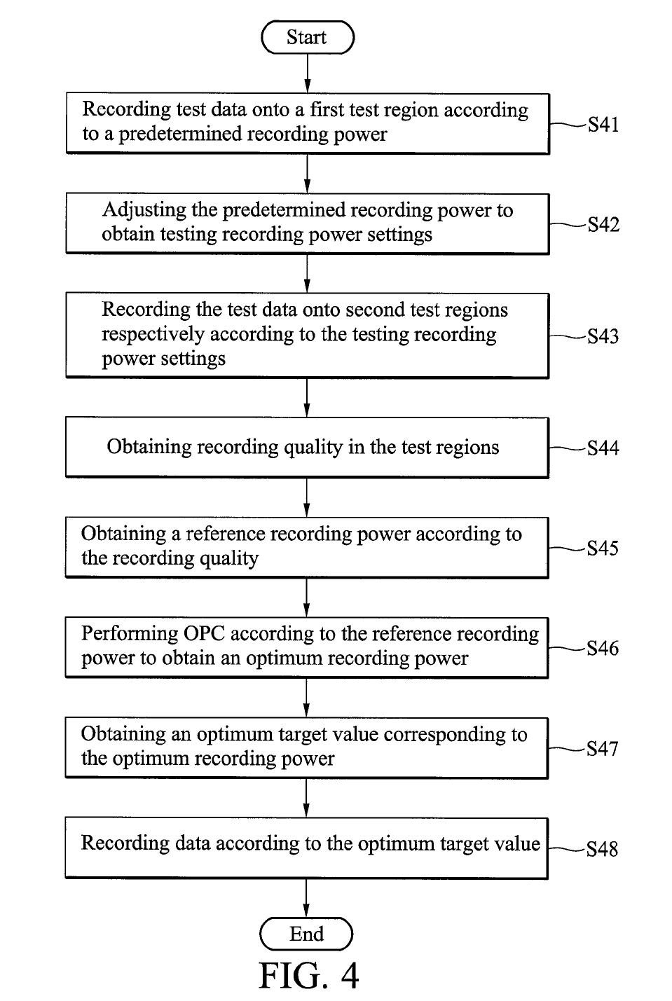

FIG. 4 is a flowchart of a method for controlling recording power to record data to an optical storage medium according to another embodiment of the invention. When an optical disk 11 is inserted, a laser diode driver 16 provides a predetermined recording power, and an optical pick up unit 14 records test data to a first predetermined test region of the optical storage medium 15 according to the predetermined recording power (S41). Next, the laser diode driver 16 adjusts the predetermined recording power to obtain a plurality of testing recording power settings (S42). In an embodiment of the invention, the testing recording power settings are generated according to the predetermined recording power and a predetermined difference.

Next, the optical pick up unit 14 records test data to second predetermined test regions of the optical storage medium 15 respectively according to the testing recording power settings (S43). For example, two second predetermined test regions are recorded with test data respectively using first and second testing recording power settings. Next, signal process unit 18 obtains recording quality respectively in the predetermined test regions corresponding to the predetermined recording power and the testing recording power settings (S44). As described, recording quality of each test region can be obtained from the PI error rate or jitter value of reproducing signal RF corresponding to each test region.

Next, the processor 19 obtains a reference recording power according to the recording quality of each predetermined test region (S45). As reference recording power is obtained, the laser diode driver 16 performs optimum power calibration according to the reference recording power to obtain an optimum recording power (S46). Next, the processor 19 obtains an optimum target value corresponding to the optimum recording power (S47). In an embodiment of the invention, the optimum recording power can be one of the generated first and second testing recording power settings, or the original predetermined recording power, depending on whether the best recording quality can be obtained. In another embodiment of the invention, the optimum recording power can be an interpolated value derived from the testing recording power settings and the original predetermined recording power. After the optimum target value is updated, the real data to be recorded is recorded to the optical storage medium 15 according to the updated optimum target value (S48).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method of recording power control when recording data to an optical storage medium, comprising:
performing optimum power calibration according to a predetermined target value to obtain a reference recording power;
adjusting the reference recording power to obtain a plurality of testing recording power settings;
recording test data to a plurality of predetermined test regions of the optical storage medium according to the reference recording power and the testing recording power settings, respectively;
obtaining recording quality respectively in the predetermined test regions corresponding to the reference recording power and the testing recording power settings;
obtaining an optimum recording power according to the recording quality;
obtaining an optimum target value corresponding to the optimum recording power; and
recording data to the optical storage medium according to the optimum target value.

2. The method as claimed in claim 1, further comprising obtaining the testing recording power settings according to the reference recording power and a predetermined difference.

3. The method as claimed in claim 2, wherein the testing recording power settings comprise a first testing recording power and a second testing recording power, the first testing recording power is a sum of the reference recording power and the predetermined difference, and the second testing recording power is a difference between the reference recording power and the predetermined difference.

4. The method as claimed in claim 3, wherein the optimum recording power is one of the first and second testing recording power settings.

5. The method as claimed in claim 3, wherein the optimum recording power is an interpolated value of at least two of the first testing recording power, the reference recording power, and the second testing recording power.

6. The method as claimed in claim 2, wherein the testing recording power settings comprise a first testing recording power, a second testing recording power, a third testing recording power, and a fourth testing recording power, the first testing recording power is a sum of the reference recording power and twice the predetermined difference, the second testing recording power is a sum of the reference recording power and the predetermined difference, the third testing recording power is a difference between the reference recording power and the predetermined difference, and the fourth testing recording power is a difference between the reference recording power and twice the predetermined difference.

7. The method as claimed in claim 1, wherein the predetermined test regions are in an inner zone of the optical storage medium.

8. The method as claimed in claim 1, wherein the predetermined test regions comprise an inner zone and an outer zone of the optical storage medium.

9. The method as claimed in claim 8, wherein the optimum recording power for different regions of the optical storage medium is adjusted according to the recording quality corresponding to the inner zone and the outer zone of the optical storage medium.

10. A method of recording power control to record data to an optical storage medium, comprising:
recording test data to a first predetermined test region of the optical storage medium according to a predetermined recording power;
adjusting the predetermined recording power to obtain a plurality of testing recording power settings;
recording the test data to a plurality of second predetermined test regions of the optical storage medium respectively according to the testing recording power settings;
obtaining recording quality in the first predetermined test region corresponding to the reference recording power and in the second predetermined test regions respectively corresponding to the testing recording power settings;
obtaining a reference recording power according to the recording quality;
performing optimum power calibration according to the reference recording power to obtain an optimum recording power;
obtaining an optimum target value corresponding to the optimum recording power; and
recording data to the optical storage medium according to the optimum target value.

11. The method as claimed in claim 10, further comprising obtaining the testing recording power settings according to the predetermined recording power and a predetermined difference.

12. The method as claimed in claim 11, wherein the testing recording power settings comprise a first testing recording power and a second testing recording power, the first testing recording power is a sum of the reference recording power and the predetermined difference, and the second testing recording power is a difference between the reference recording power and the predetermined difference.

13. The method as claimed in claim 12, wherein the reference recording power is one of the first and second testing recording power settings.

14. The method as claimed in claim 12, wherein the reference recording power is an interpolated value of at least two of the first testing recording power, the reference recording power, and the second testing recording power.

15. The method as claimed in claim 11, wherein the testing recording power settings comprise a first testing recording power, a second testing recording power, a third testing recording power, and a fourth testing recording power, the first testing recording power is a sum of the reference recording power and twice the predetermined difference, the second testing recording power is a sum of the reference recording power and the predetermined difference, the third testing recording power is a difference between the reference recording power and the predetermined difference, and the fourth testing recording power is a difference between the reference recording power and twice the predetermined difference.

16. The method as claimed in claim 10, wherein the first predetermined test region and the second predetermined test region are in an inner zone of the optical storage medium.

17. The method as claimed in claim 10, wherein the first predetermined test region comprise an inner zone and an outer zone of the optical storage medium.

18. The method as claimed in claim 17, wherein the optimum recording power for different regions of the optical storage medium is adjusted according to the recording quality corresponding to the inner zone and the outer zone of the optical storage medium.

19. An optical recording apparatus to record data to an optical storage medium comprising a plurality of predetermined test regions, comprising:
a laser diode driver performing optimum power calibration according to at least one of predetermined target values to obtain at least one of reference recording power, and adjusting the reference recording power to obtain at least one of testing recording power settings;
a signal process device obtaining at least one of recording qualities respectively in the predetermined test regions corresponding to the reference recording power and the testing recording power settings; and
a processor obtaining an optimum recording power according to the recording quality, and obtaining an optimum target value corresponding to the optimum recording power.

20. The optical recording apparatus as claimed in claim 19, wherein the laser diode driver obtains the testing recording power settings according to the reference recording power and a predetermined difference.

21. The optical recording apparatus as claimed in claim 20, wherein the testing recording power settings comprise a first testing recording power and a second testing recording power, wherein the first testing recording power is a sum of the reference recording power and the predetermined difference, and the second testing recording power is a difference between the reference recording power and the predetermined difference.

22. The optical recording apparatus as claimed in claim 21, wherein the optimum recording power is one of the first and second testing recording power settings.

23. The optical recording apparatus as claimed in claim 21, wherein the optimum recording power is an interpolated value of two of the first testing recording power, the reference recording power, and the second testing recording power.

24. The optical recording apparatus as claimed in claim 19, wherein the predetermined test regions are in an inner zone of the optical storage medium.

25. The optical recording apparatus as claimed in claim 19, wherein the predetermined test regions comprise an inner zone and an outer zone of the optical storage medium.

26. The optical recording apparatus as claimed in claim 25, wherein the optimum recording power for different regions of the optical storage medium is adjusted according to the recording quality corresponding to the inner zone and the outer zone of the optical storage medium.

27. An optical recording apparatus to record data to an optical storage medium, comprising:
an optical pickup recording test data to a first predetermined test region of the optical storage medium according to a predetermined recording power, and recording the test data to a plurality of second predetermined test regions of the optical storage medium respectively according to a plurality of testing recording power settings;
a laser diode driver providing the predetermined recording power, adjusting the predetermined recording power to obtain the testing recording power settings, and performing optimum power calibration according to a reference recording power to obtain an optimum recording power;
a signal process device obtaining recording quality in the first predetermined test region corresponding to the reference recording power and in the second predetermined test regions respectively corresponding to the testing recording power settings; and
a processor obtaining the reference recording power according to the recording quality, and obtaining an optimum target value corresponding to the optimum recording power.

28. The optical recording apparatus as claimed in claim 27, wherein the laser diode driver obtains the testing recording power settings according to the predetermined recording power and a predetermined difference.

29. The optical recording apparatus as claimed in claim 28, wherein the testing recording power settings comprise a first testing recording power and a second testing recording power, the first testing recording power is a sum of the reference recording power and the predetermined difference, and the second testing recording power is a difference between the reference recording power and the predetermined difference.

30. The optical recording apparatus as claimed in claim 29, wherein the reference recording power is one of the first and second testing recording power settings.

31. The optical recording apparatus as claimed in claim 29, wherein the reference recording power is an interpolated value of the first and second testing recording power settings.

32. The optical recording apparatus as claimed in claim 27, wherein the first predetermined test region and the second predetermined test region are in an inner zone of the optical storage medium.

33. The optical recording apparatus as claimed in claim 27, wherein the first predetermined test region comprise an inner zone and an outer zone of the optical storage medium.

34. The optical recording apparatus as claimed in claim 33, wherein the optimum recording power for different regions of the optical storage medium is adjusted according to the recording quality corresponding to the inner zone and the outer zone of the optical storage medium.
